(19) United States
(12) Patent Application Publication
(10) Pub. No.: US 2006/0012830 A1
(43) Pub. Date: Jan. 19, 2006

(54) Image processing device, image processing method, and image processing program

(76) Inventor: Seiji Aiso, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/177,701

(22) Filed: Jul. 8, 2005

(30) Foreign Application Priority Data
Jul. 12, 2004 (JP) 2004-204745

(51) Int. Cl. G06K 15/00

(52) U.S. Cl. 358/3.27

(57) ABSTRACT

The CPU 200 acquires multiple frame data F(a) arranged in a time series. The CPU 200 calculates a correction value for correction of a positional shift of a subject among images f(a) represented by the multiple frame data F(a), and using this correction value corrects positional shift of the subject in the multiple frame data F(a). The CPU calculates weights W(a, i) established for each of the multiple frames data F(a). The weights W(a, i) are established with reference to a possibility for degrading quality of a image represented by a high resolution image data when each of the multiple image data uses for creating the high resolution image data. The CPU 200 combines the corrected multiple image data F(a) using the weights W(a, i) to create high resolution image data.

### BACKGROUND OF THE INVENTION

1. Field of the Invention

The present invention relates to image processing, and in particular relates to a technology for creating high-resolution image data from multiple image data of comparatively low resolution.

2. Description of the Related Art

There are instances in which data of multiple similar images in a time series, such as frame images making up motion video data created by a digital video camera, or image data shot continuously by a digital still camera, are acquired. Technologies for using such data of multiple similar images as source image data to create image data of higher resolution than the source data are known.

In the technologies mentioned above, where multiple continuous frame images making up motion video data are used as source data for example, the image data of the frame images is analyzed, and motion vectors across frame images (corresponding to positional shift among frame images) are calculated in units finer than pixel pitch. On the basis of the calculated motion vectors, the frame images are then combined to create image data of high resolution.

However, in some instances the multiple frame images used in combining may include data giving information that causes degradation of picture quality in a high resolution image generated in this way. For example, in certain instances, some of the frame images used in combining produce “movement” with respect to the frame image serving as a base for combining. Such “movement” refers not to uniform change of the frame image as a whole, such as jiggle of the subject occurring with camera shake, but rather to localized change occurring in part of a subject in the frame image. When a frame image in which such “movement’ has occurred and a base frame image are superimposed, it will not be possible to correctly superimpose the two so that the subject is aligned between them in the area in which “movement” has occurred. As a result, a frame image in which “movement” has occurred will produce a double image of the subject that has experienced “movement”, creating the risk of degraded picture quality of a high resolution image created therefrom.

The above problem is not limited to motion video data created with a digital video camera, but is common as well to instances where multiple image data continuously shot with a digital still camera is used.

### SUMMARY OF THE INVENTION

With a view to addressing the problem outlined above, it is an object of the present invention to improve picture quality of a high resolution image created on the basis of multiple image data.

In order to solve the above-mentioned problem, a first aspect of the present invention provides an image processing device that creates high resolution image data using multiple image data, wherein the multiple image data are respectively composed of multiple pixel data, wherein the multiple image data are arranged in a time series, wherein the high resolution image data has higher resolution than the multiple image data. The image processing device of the first aspect of the present invention comprises: an image data acquisition module that acquires the multiple image data; a correction value calculation module that calculates a correction value for correction of a positional shift of a subject among images represented by the multiple image data; a positional shift correction module that corrects the positional shift of the subject about the multiple image data respectively using the calculated correction value; a weight establishing module that establishes a weight for each of the multiple image data, wherein the weight decreases as a degradation-possibility increases and increases as the degradation-possibility decreases, wherein the degradation-possibility is a possibility for degrading quality of a image represented by the high resolution image data when each of the multiple image data uses for creating the high resolution image data; and a high resolution image creating module that creates the high resolution image data by combining the corrected multiple image data using the established weight.

According to the image processing device of the first aspect of the present invention, when creating high resolution image data by combining multiple images arranged in a time series, a weight established for each of the multiple images is used. The weight decreases as a possibility increases, and the weight increases as the possibility decreases. The possibility is a possibility for degrading quality of a image represented by the created high resolution image data (hereinafter termed created image data). Therefore, the effect on the created image data of image data having a high possibility of causing degradation of picture quality of a created image is smaller. As a result, picture quality degradation of the created image can be reduced.

In the image processing device of the first aspect of the present invention, the establishment of the weight may be carried out using an indicator associated with each of the multiple image data, the indicator representing a degree of the degradation-possibility. In this case, it is possible to establish a adequate weight using an indicator representing a degree of the degradation-possibility.

In the image processing device of the first aspect of the present invention, the indicator may include a time interval between each of the multiple image data and base image data selected from among the multiple image data, and the weight establishing module may comprise a time interval-based weight establishing module that establishes smaller weight for image data having the longer time interval, and larger weight for image data having the shorter time interval. An image represented by image data having long time interval from the base image data is highly likely to have experienced the aforementioned movement”. The “movement” cause the degradation of picture quality. When combining the multiple image data, using the weight according to the time interval can minimize the effect on the created image data by such image data that is highly likely to degrade picture quality.

In the image processing device of the first aspect of the present invention, the indicator may include a magnitude of the correction value between an image represented by each of the multiple image data and an image represented by base image data selected from among the multiple image data, and the weight establishing module may comprise a positional shift level-based weight establishing module that establishes smaller weight for image data having the larger correction value, and larger weight for image data having the smaller correction value. An image data having a large positional shift with respect to the base image data has the aforementioned “movement.” in the image thereof. The correction value stands for the level of positional shift with respect to the base image data. Therefore, when combining the multiple image data, using the weight according to the correction value can minimize the effect on the created image data by such image data that is highly likely to degrade picture quality.

In the image processing device of the first aspect of the present invention, the indicator may include an inter-pixel distance between second pixel data and closest pixel data, wherein the second pixel data forming the created high resolution image data, wherein the closest pixel data is the closest to the second pixel data among all pixel data forming each of the corrected multiple image data, wherein the inter-pixel distance is set for each of the second pixel data, and the weight establishing module may comprise inter-pixel distance-based weight establishing module that establishes smaller weight for image data having the longer inter-pixel distance, and larger weight for image data having the shorter inter-pixel distance. An image data with the long inter-pixel distance having a high risk to provide information that gives rise to degradation of picture quality. Therefore, when combining the multiple image data, using the weight established for each of the created image data according to the inter-pixel distance can minimize the effect on the created image data by such image data that is highly likely to degrade picture quality. Accordingly, degradation of the picture quality of the created image can be reduced.

In the image processing device of the first aspect of the present invention, the high resolution image creating module may comprise: a pixel establishing module that establishes a position of a pixel forming an image represented by the high resolution image data; a single image reference pixel value calculating module that calculates a single image reference pixel value on a per-pixel data basis, wherein the single image reference pixel value is a pixel value at the established position calculated on the basis of one image data among the corrected multiple image data; and a pixel data creating module that calculates a weighted average of the single image reference pixel values using the established weights to create pixel data at the established position using the weighted average as a pixel value. In this case, a weighted average of the single image reference pixel values on the basis of each of the multiple image data is calculated using the aforementioned weights. Therefore, the effect on the created image data by such image data that is highly likely to degrade picture quality is minimized. Accordingly, degradation of the picture quality of the created image can be reduced.

In the image processing device of the first aspect of the present invention may further comprise a memory that stores a table in which correspondence between the indicator and the weight is recorded in advance. And the weight may be established with reference to the table, or the weight may be established using a prescribed relational expression representing correspondence between the indicator and the weight. In this case, it is readily impossible to execute creation of the high resolution image data using the aforementioned weight.

In the image processing device of the first aspect of the present invention, when duplicative image data exists, wherein the duplicative image data is one of the corrected multiple image data, wherein each of pixels forming an image represented by the duplicative image data is located at substantially identical coordinates as each of pixels of an image represented by another one of the corrected multiple image data in the coordinate space of an image represented by the high resolution image data, the creation of the high resolution image data may be executed without using the duplicative image data. When each pixel of an image represented by one image data and an image represented by another image data is located at substantially identical coordinates, that is, the locations between them are duplicated, using both image data for combining may not contribute to picture quality of the created high resolution image data. Such duplicative image data is not used in the high resolution image combining process, whereby the processing load associated with the high resolution image combining process can be reduced. Additionally, since less frame image data is used for combining, the risk of double images can be reduced.

In the image processing device of the first aspect of the present invention, when a first value meets a predetermined criterion, wherein the first value is the correction value between an image represented by one of the corrected multiple image data and an image represented by another of the corrected multiple image data, the one of the corrected multiple image data may be determined to be the duplicative image data. In this case, by using the calculated correction value between images, whether the duplicative image data exists or not can be readily determined.

The technique of the invention may be actualized by any of diverse applications such as an image processing method, a computer program, a recording medium on which the computer program is stored, and data signals that include the computer program and are embodied in carrier waves.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is an illustration of an exemplary image processing system that includes the image processing device pertaining to the embodiment;

FIG. 2 is a functional block diagram of the personal computer 20 (CPU 200) pertaining to the embodiment;

FIG. 3 is a flowchart showing the processing routine of image processing according to the embodiment;

FIG. 4 is an illustration showing positional shift between an image f(0) represented by base frame image data F(0), and one other frame image data F(a);

FIG. 5 is an illustration showing correction of positional shift, performed on frame image data F(a) with the base frame image data F(0);

FIG. 6 is a first illustration of a method for calculating positional shift correction value by the gradient method;

FIGS. 7A-B are second illustrations of a method for calculating positional shift correction value by the gradient method;

FIG. 8 is a model illustration showing rotation correction value of a pixel;

FIG. 9 is a flowchart showing the processing routine of the high resolution image combining process;

FIG. 10 is an enlarged illustration of an example of the base image f(0) and images f(1)-f(3);

FIG. 11 is an illustration showing an interpolation process by the bi-linear method;

FIGS. 12A-B are illustrations describing calculation of inter-pixel distance-based weight Ws(a, i);

FIGS. 13A-B are an illustrations describing calculation of time interval-based weight Wt(a);

FIG. 14 is a simplified diagram showing a table in which time interval-based weights Wt(a) are recorded;

FIG. 15 is a flowchart showing the processing routine of image processing according to the embodiment;

FIG. 16 is a flowchart showing the processing routine of the frame image data selection process; and

FIG. 17 is an enlarged illustration showing a baseline image f(0) and images f(4), f(5).

### DESCRIPTION OF THE PREFERRED EMBODIMENTS

Following, the image processing of the present invention is described based on the embodiments with reference to drawings.

### A. First Embodiment

Arrangement of Image Processing System

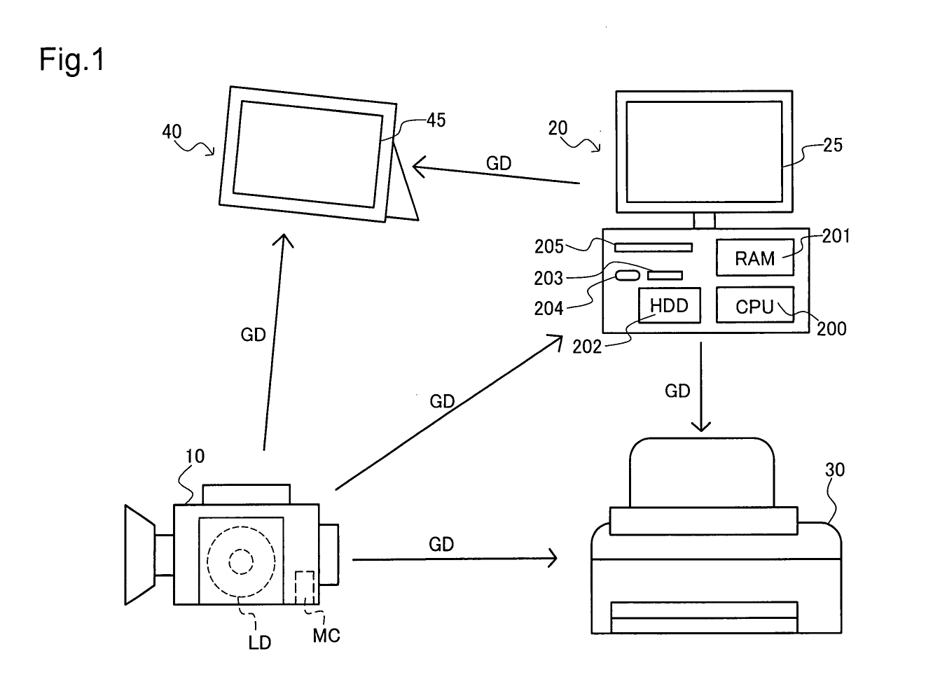

FIG. 1 is an illustration of an exemplary image processing system that includes the image processing device pertaining to First Embodiment. The following description of the arrangement of an image processing system enabling implementation of the image processing device pertaining to First Embodiment refers to FIG. 1.

The image processing system includes a digital video camera 10 as the photographing device for creating image data, a personal computer 20 as the image processing device for creating high resolution image data from multiple image data created by the digital video camera 10, and a color printer 30 as the output device for outputting images using image data. Besides the printer 30, an LCD display monitor 25 or display device 40 could be used as output devices.

The digital video camera 10 is a camera for creating multiple image data GD1-GDn arranged in a time series with a given frame rate. Hereinafter, each the image data GD1-GDn is termed frame image data GD1-GDn respectively. Each of these image data is created by focusing optical information onto a digital device, for example, a CCD or photoelectron multiplier to convert it to a digital signal. The digital video camera 10 stores the created multiple image data GD1-GDn as a single image file GF (video file) on an optical disk LD, for example, DVD-RAM. Of course, image file GF storage is not limited to an optical disk LD, it being possible to employ various other recording media such as digital videotape, a memory card MC.

The personal computer 20 is a computer of the type used ordinarily, including a CPU 200 for executing an image processing program that includes a process for creating high resolution image data; RAM 201 for temporary storage of results of CPU 200 operations, image data, and the like; and a hard disk drive (HDD) 202 for storing the image processing program. The personal computer 20 additionally includes a disk drive 205 for optical disks LD such as DVDs; a card slot 203 for inserting a memory care MC; and an input/output terminal 204 for connecting a connector cable from the digital video camera 10.

The printer 30 is one capable of outputting image data as a color image, for example, an ink jet printer that forms images by ejecting ink of the four colors cyan, magenta, yellow, and black onto a printing medium to form a dot pattern. Alternatively, the printer may be of electrophotographic type that transfers and fixes color toner onto a printing medium to form an image. Besides the four colors mentioned above, the printer could use light cyan, light magenta, red, and blue.

The display device 40 has a display 45 to display an image of image data. For example, The display device 40 functions as electronic photographic flame. As the display 45, a liquid crystal display or organic EL display may be used, for example.

The printer 30 and the display device 40 may be furnished with the image processing functionality furnished to the personal computer 20, allowing them to be used as stand-alone devices for image processing and image output. In this case, the printer 30 or display device 40 can acquire image data without the aid of the personal computer 20, for example, directly from a memory card MC or other recording medium, or from the digital video camera 10 via a cable, thereby enabling the printer 30 or display device 40 to each function as the image processing device of the embodiment.

In the following description, it is assumed that image data created by the digital video camera 10 is sent to the personal computer 20, with image processing to produce high resolution image data being carried out on the personal computer 20.

Functional Arrangement of Personal Computer 20

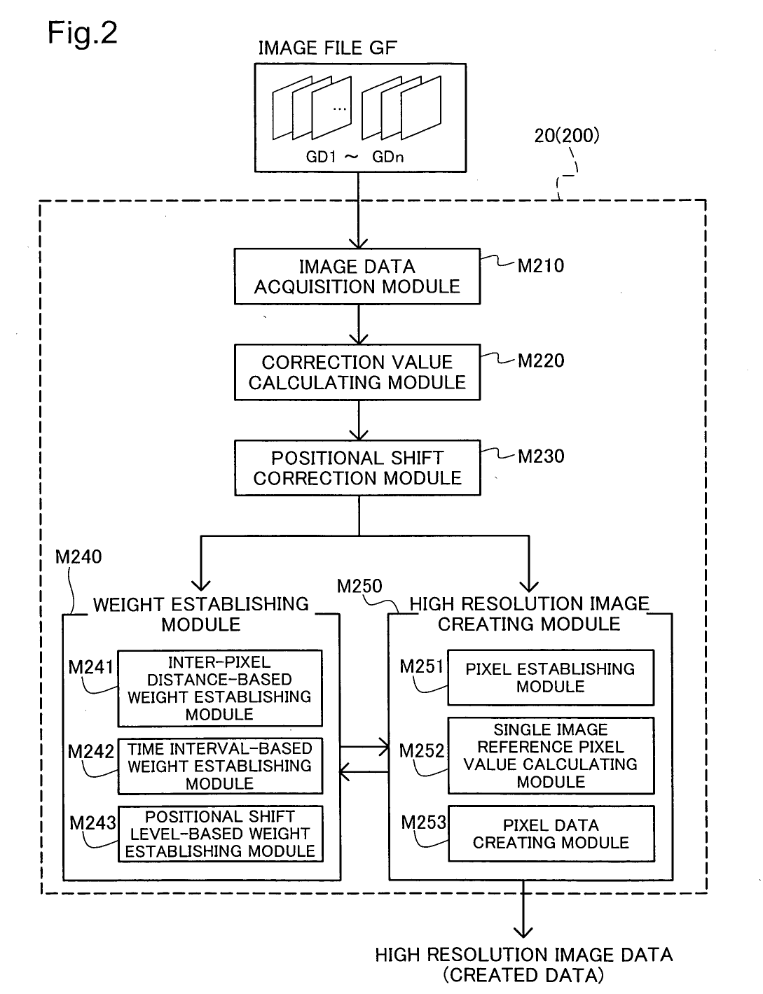

FIG. 2 is a functional block diagram of the personal computer 20 (CPU 200) pertaining to the embodiment. The following overview of the functional arrangement of the personal computer 20 (CPU 200) makes reference to FIG. 2.

An image data acquisition module M210 acquires multiple frame image data in a time series, selected from among the frame image data GD1-GDn recorded in an image file GF.

A correction value calculating module M220 calculates a correction value for correction of a positional shift occurring among images represented by multiple frame image data acquired by the image data acquisition module M210. Hereinafter, the correction value calculated by module M220 is termed the positional shift correction value. Using the positional shift correction value acquired from the correction value calculating module M220, a positional shift correction module M230 then corrects the aforementioned positional shift.

A weight establishing module M240 establishes a weight W(a, i) for each of the multiple frame image data. The weight establishing module M240 includes an inter-pixel distance-based weight establishing module M241, a time interval-based weight establishing module M242, and a positional shift level-based weight establishing module M243. The inter-pixel distance-based weight establishing module M241, time interval-based weight establishing module M242, and positional shift level-based weight establishing module M243 respectively establish an inter-pixel distance-based weight Ws(a, i) that take inter-pixel distance into consideration, time interval-based weights Wt(a) that take time interval into consideration, and positional shift level-based weights Wu(a) that take positional shift correction value into consideration. Final weights W(a, i) are established using these three weights Ws(a, i), Wt(a), Wu(a) as elements. These weights Ws(a, i), Wt(a), Wu(a) will be described later.

A high resolution image creating module M250, using weights W(a, i) acquired from the weight establishing module M240, combines the multiple frame image data to create high resolution image data (created image data) of higher resolution than the frame image data. The high resolution image creating module M250 includes a pixel establishing module M251, a single image reference pixel value calculating module M252, and a pixel data creating module M253.

The pixel establishing module M251 establishes locations of pixels forming an image G represented by the created image data. That is, it establishes a pixel of note G(i) of a created image. The single image reference pixel value calculating module M252 calculates, for each of the multiple frame image data, a pixel value of a pixel of note G(i) calculated on the basis of one of the multiple frame image data (hereinafter termed “single image reference pixel value”). The pixel data creating module M253 creates a final pixel value of a pixel of note G(i). The weighted average value of single image reference pixel values calculated using the weight W(a, i) is designated as the final pixel value of the pixel of note G(i).

Image Processing in Personal Computer 20

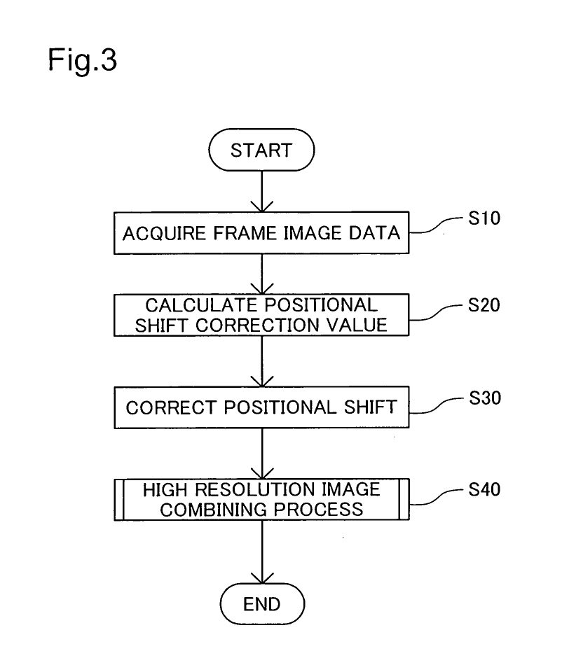

The following description of image processing executed in the personal computer 20 makes reference to FIGS. 3-14.

FIG. 3 is a flowchart showing the processing routine of image processing according to the embodiment. In accordance with a user instruction, the personal computer 20 (CPU 200) runs the image processing program. In accordance with a user instruction, the CPU 200 reads an image file GF from an optical disk LD or the like, and plays back the video represented by the frame image data GD1-GDn stored in the image file GF.

During video playback, when an instruction to acquire frame image data is input by the user, the CPU 200 acquires multiple consecutive frame image data from among the frame image data GD1-GDn making up the video data MD (Step S10). Each frame of image data is composed of tone data (pixel data) representing tone values of pixels (pixel values) in a dot matrix array. Pixel data may consist of YCbCr data composed of the three pixel values Y (luminance), Cb (blue color difference), Cr (red color difference); of RGB data composed of the three pixel values R (red), G (green), B (blue); or other such data. In the embodiment, it is assumed that the CPU 200 acquires frame image data instructed by the user, as well as frame image data equivalent to ten frames preceding and following that frame in a time series (for a total equivalent of 21 frames). The CPU 200 temporarily stores the acquired 21 frame image data in RAM 201.

In the description hereinbelow, frame image data number of the 21 acquired frames (hereinafter termed “frame number”) is denoted as a, and frame image data for frame number a is denoted as frame image data F(a) (a=−10 to +10). The image represented by frame image data F(a) is denoted as image f(a) (a=−10 to +10). The frame image data F(0) selected by the user, i.e. the frame image data F(0) at midpoint in the time series between the 21 acquired frame image data F(a), is termed the base frame image data.

If the user inputs an instruction to create a high resolution still image from the acquired frame images, the CPU 200 first calculates a correction value (hereinafter termed positional shift correction value) for the purpose of eliminating positional shift of a subject among images represented by frame image data F(a) (Step S20). Here, positional shift and positional shift correction will be described.

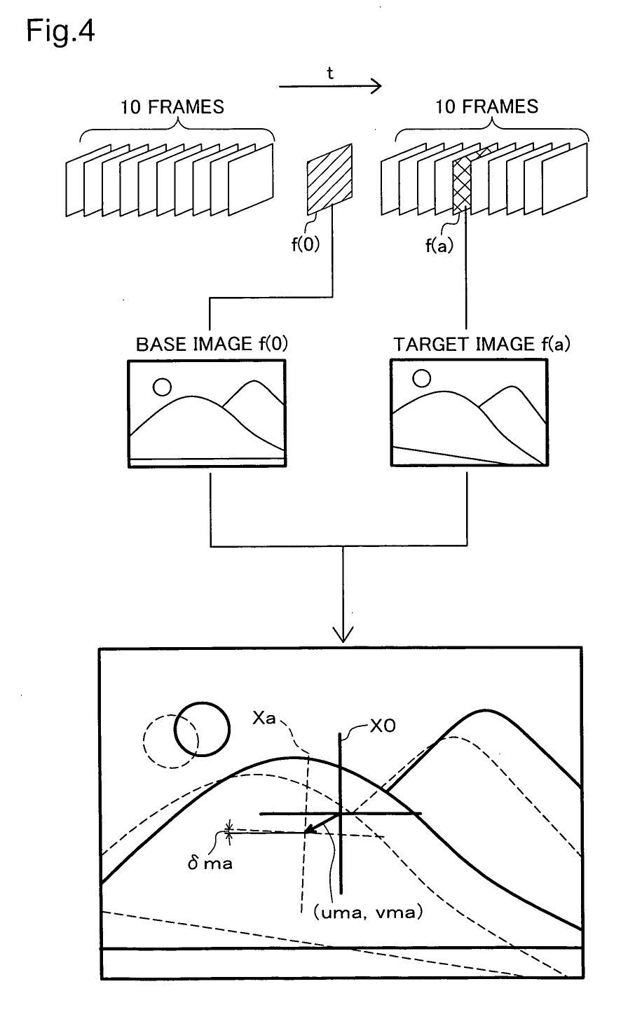

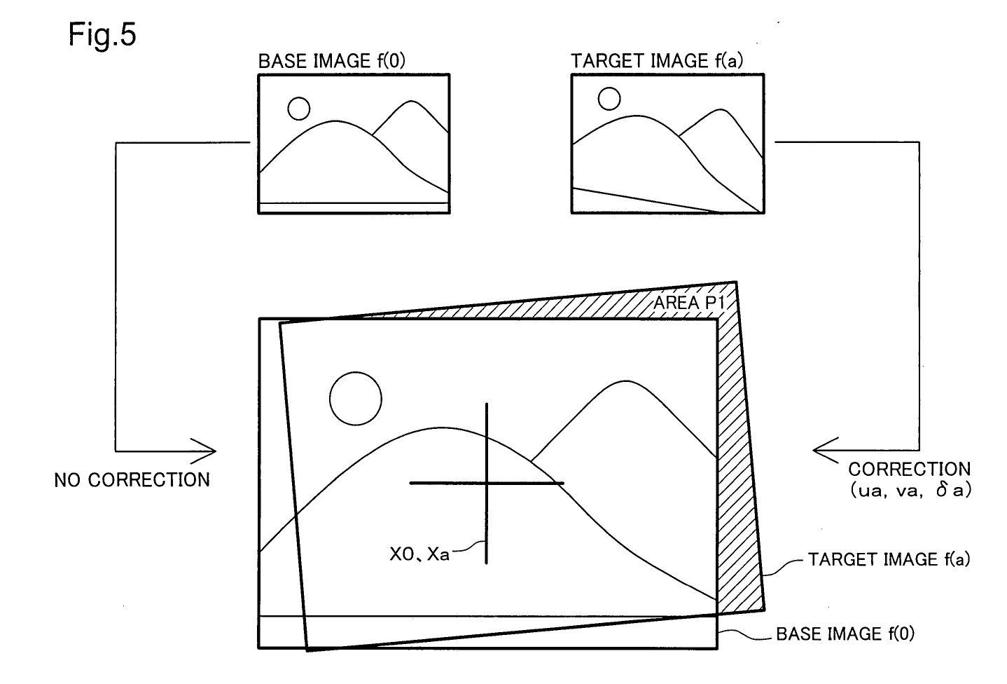

FIG. 4 is an illustration showing positional shift between an image f(0) represented by base frame image data F(0), and one other frame image data F(a). FIG. 5 is an illustration showing correction of positional shift, performed on frame image data F(a) with the base frame image data F(0) as the base. The base frame image data F(0) is used as the base when calculating positional shift correction value. Specifically, positional shift correction value with respect to the base frame image data F(0) is calculated for each of the 20 frame image data F(a) (a=−10 to 1, 1 to +10), ten of which precede and ten of which follow the base.

Positional shift is expressed by a combination of translational shift in the lateral direction and vertical direction of the image and rotational shift about an axis at the image center. In FIG. 4, in order to make it easy to ascertain the positional shift of image f(a) with respect to the base image f(0), the edges of image f(0) and the edges of image f(a) are superimposed. A virtual cross image X0 is added on the center location on the image f(0). On image f(a), there is shown a cross image Xa which represents an image resulting from positional shift of the cross image X0 in the same manner as image f(a). In order to make it even easier to ascertain the positional shift, image f(0) and cross image X0 are represented with thick solid lines, while image f(a) and cross image Xa are represented with thin broken lines.

In the embodiment, as shown in FIG. 4, translational shift level in the lateral direction is denoted as “um” and that in the vertical direction as “vm”, while the level of rotational shift is denoted as “δm”. And the positional shifts of image f(a) with respect to image f(0) are accordingly expressed as “uma”, “vma” and “δma” respectively. For example, for an image f(3) represented by the third frame image data following in the time series the image f(0) of the frame image data F(0), the positional shifts thereof with respect to image f(0) are denotes as um3, vm3, dm3 respectively.

The terminology ‘correction’ herein refers to converting the coordinates of pixels in frame image data so that locations of pixels in the image are shifted by u in the lateral direction, shifted by v in the vertical direction, and shifted to a location rotated by δ. u represents the level of correction of translation in the lateral direction, and w represents the level of correction of translation in the vertical direction. δ represents the level of correction of rotation.

Where positional shift correction values of frame image data F(a) with respect to frame image data F(0) are denoted as “ua”, “va” and “δa”, the relationships ua=−uma, va=−vma, and δa=−δma will exist among positional shift correction values and the positional shift mentioned previously. For example, positional shift correction values u3, v3 and δ3 for frame image data F(3) are represented by u3=−um3, v3=−vm3, and d3=−δm3.

As described previously, by carrying out correction on frame image data F(a) using positional shift correction values ua, va, δa, subjects of image f(a) and base image f(0) can be aligned with each other. Specifically, where image f(0) and image f(a) represented by corrected frame image data F(a) are superimposed, the corrected image f(a) will be in partial alignment with image f(0) as shown in FIG. 5. In order to make the result of correction easier to ascertain, in FIG. 5 as in FIG. 4 there are shown a virtual cross image X0 and cross image Xa; in FIG. 5, as a result of correction, cross image X0 and cross image Xa are aligned with one another.

The terminology ‘Partial alignment’ herein refers to the following. As shown in FIG. 5 for example, a hatched area P1 is an area present only in image f(a), with no corresponding area being present in image f(0). Even where correction is carried out in the manner described above, nevertheless, due to shift there exist an area present in image f(0) or one present in f(a) only, so that image f(a) does not completely align with image f(0); thus, it is referred to as partial alignment.

Returning now to FIG. 3, the process of calculating positional shift correction values ua, va, δa will be described. In order to preserve adequate picture quality in the created image G created subsequently, it is necessary that positional shift correction values be calculated with finer accuracy than the pixel units of image f(a) (so-called sub-pixel accuracy). For example, translation correction values ua, va are calculated in 1/16 pixel units, while rotational correction value δa is calculated in 1/100 degree units. Accordingly, to calculate positional shift correction values, there is employed an analysis method able to calculate correction values with finer accuracy than the pixel units. In the embodiment, CPU 200, using pixel values (e.g. luminance values) of pixel data of frame image data F(a) targeted for correction and the base frame image data F(0), positional shift correction values are calculated by the gradient method. First, a description of the gradient method follows.

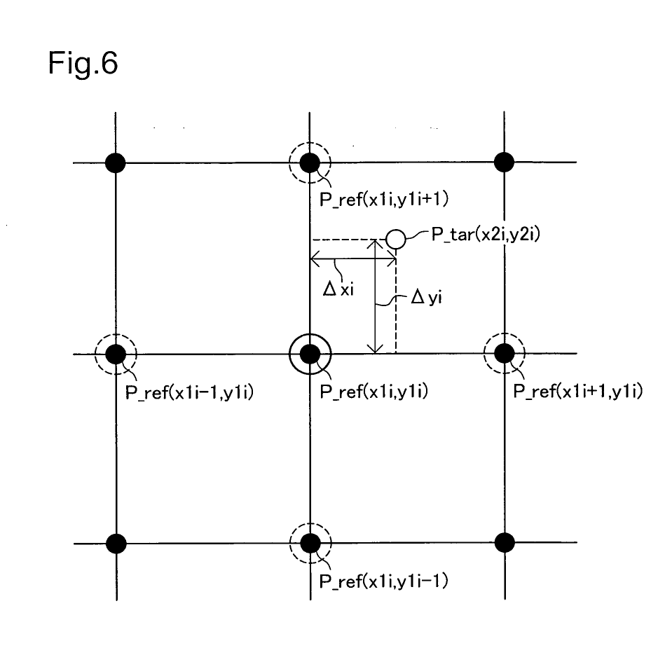

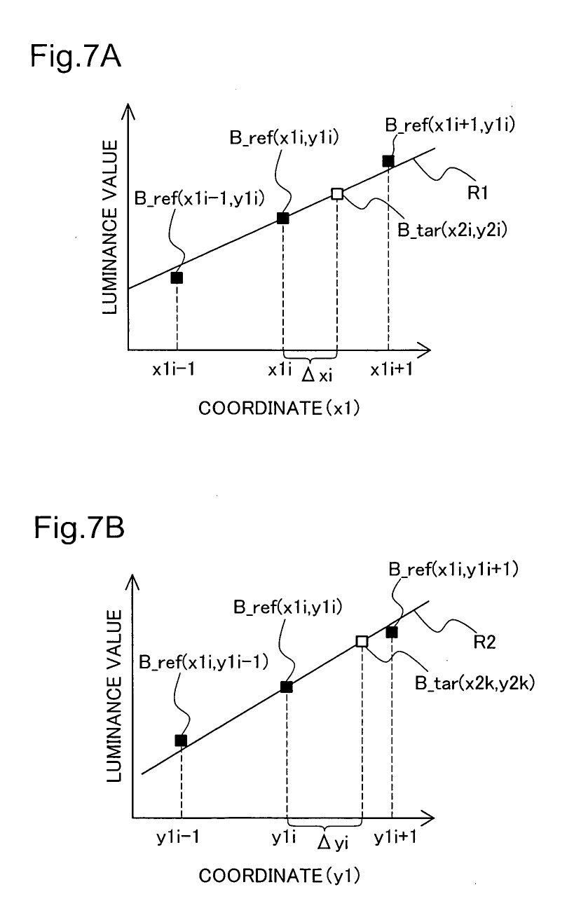

The following description of the gradient method makes reference to FIG. 6 and FIGS. 7A-B. FIG. 6 is a first illustration of a method for calculating positional shift correction value by the gradient method. FIGS. 7A-B are second illustrations of a method for calculating positional shift correction value by the gradient method. In FIG. 6, the black circles represent pixels of the base image f(0); for example, (x1i, y1i) represents the coordinates of a pixel on Cartesian coordinates having the center of image f(0) as the origin. The white circle represents a pixel P_tar (x2i, y2i) of an image f(a) superimposed on image f(0) so as to partially align therewith, with coordinates (x2i, y2i) representing coordinates on Cartesian coordinates having the center of image f(a) as the origin. The following description proceeds on the assumption that pixel P_tar (x2i, y2i) is the target pixel i. Let it be supposed that, where superimposed partially aligned with image f(0), the target pixel P_tar (x2i, y2i) is situated at location (x1i+Δxi, y1i+Δyi) in proximity to pixel P_ref (x1i, y1i) of image f(0). Here, i is a number for distinguishing pixels.

First, the pixel P_ref (x1i, y1i) of image f(0) corresponding to the target pixel P_{—tar (x2}i, y2i), and the four pixels P_ref (x1i+1, y1i), P_ref (x1i−1, y1i), P_ref (x1i, y1i+1), P_ref (x1i, y1i−1) situated above, below and to either side thereof, are selected as reference pixels.

FIG. 7A shows a method for estimating the distance Δxi on the x1 axis, between the target pixel P_tar (x2i, y2i) and pixel P_ref (x1i, y1i), where image f(a) and image f(0) are superimposed partially aligned. First, using the luminance values B_ref (x1i, y1i), B_tar (x1i−1, y1i), B_ref (x1i+1, y1i) of pixel P_ref (x1i, y1i) and the neighboring pixels P_ref (x1i−1, y1i), P_ref (x1i+1, y1i) to the left and right thereof, a luminance gradient ΔBxi is calculated. ΔBxi is a quantity represented by the slope of the line R1 in FIG. 7A, and is the luminance gradient in proximity to pixel P_ref (x1i, y1i). For example, an approximate straight line could be derived using three pixel values, and the slope thereof used as ΔBxi; or the slope of a line connecting left and right pixel values {B_ref (x1i−1, y1i), B_ref (x1i+1, y1i)}/2 could be used as ΔBxi.

Where the luminance value B_tar (x2i, y2i) of the target pixel P_tar (x2i, y2i) is assumed to be on line R1 shown in FIG. 7A, the relationship
ΔBxi·Δxi=B_tar(x2i, y2i)−B_ref(x1i, y1i)
is true. Here, where B_tar (x2i, y2i) and B_ref (x1i, y1i) are represented simply as B_tar and B_ref, the relationship
ΔBxi·Δxi−(B_tar−B_ref)=0 (1)
is true.

FIG. 7B shows a method for estimating the distance Δyi on the y1 axis, between the target pixel P_tar (x2i, y2i) and pixel P_ref (x1i, y1i), where image f(a) and image f(0) are superimposed partially aligned. By means of a method analogous to estimating Δx, described above, the equation
ΔByi·Δyi−(B_tar−B_ref)=0 (2)
is derived. Here, by calculating Δxi and Δyi that fulfill Eq. (1) and Eq. (2), the location of the target pixel P_tar (x2i, y2i) on image f(0) can be ascertained.

Expanding on this approach, to derive common correction values (ua, va, δa) for all pixels forming image f(a), it would be conceivable to minimize the following S², using the method of least squares.
S²=S{ΔBxi·Δxi+ΔByi·Δyi−(B_tar−B_ref)}² (3)

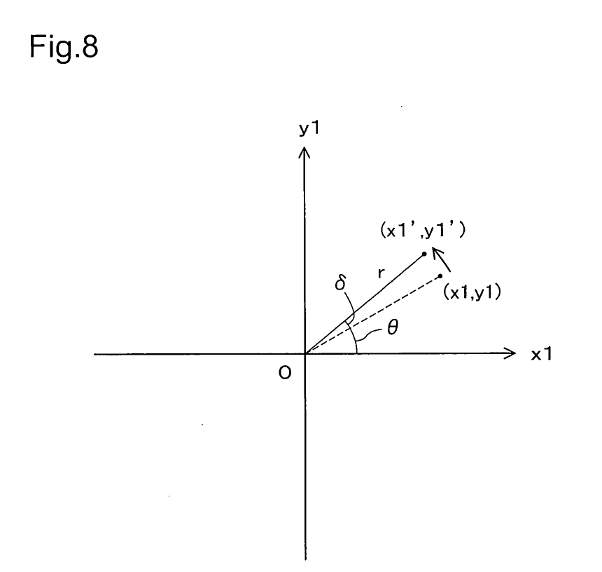

Here, the relationship of correction values (ua, va, δa) and Δxi, Δyi for each pixel i will be considered. FIG. 8 is a model illustration showing rotation correction value of a pixel. Where the distance of a coordinate (x1, y1) of image f(0) from the origin O is denoted by r and the rotation angle from the x1 axis as θ, r and θ are given by the following equations.
r=(x1²+y1²)^{1/2} (4)
θ=tan⁻¹(y1/x1) (5)

Here, it is assumed that image f(a) has undergone only rotational shift with respect to image f(0), without any translational shift; and that the pixel at coordinates (x2, y2) in image f(a) is located at coordinates (x1′, y1′) having been rotated by rotation correction value δ from the location of coordinates (x1, y1) on image f(0). The level of movement in the x1 axis direction Δx and the level of movement in the y1 axis direction Δy produced by this rotation correction value δ are derived from the following equations.
Δx=x1′−x1≈r·δa·sin θ=−δa·y1 (6)
Δy=y1′−y1≈r·δa·cos θ=δa·x1 (7)

Accordingly, Δxi, Δyi for each pixel i in Eq. (3) given previously can be represented as in the following equations, using the correction values (u, v, δ).
Δxi=ua−δa·y1i (8)
Δyi=va+δa·x1i (9)

Here, x1i and y1i are the coordinates of pixel P_ref (x1i, y1i) in image f(0).

Substituting Eq. (8), (9) above into Eq. (3) previously gives the following equation.
S²=Σ{ΔBxi·(ua−δa·y1i)+ΔByi·(va+δa·x1i)−(B_tar−B_ref)}² (10)

That is, when the corresponding coordinate values and luminance values for all pixels of image f(a) are substituted into Eq. (18), correction values (ua, va, δa) that minimize S² can be derived by the method of least squares.

The description continues returning to FIG. 6. Once positional shift correction value has been calculated for all 20 images f(a) (a=10−1, 1−10), the CPU 200, using the calculated shift correction value, performs positional shift correction on frame image data F(a) (a=10−1, 1−10) (Step S30). As a result, the 21 images including 20 images f(a) (a=10−1, 1−10) and the base image f(0) can be superimposed so as to partially align (see FIG. 5).

The CPU 200 then executes processing to combine the 21 superimposed frame image data F(a) and create high resolution image data representing an image of higher resolution than frame image data F(a) (Step S40). This processing refers to high resolution image combining process.

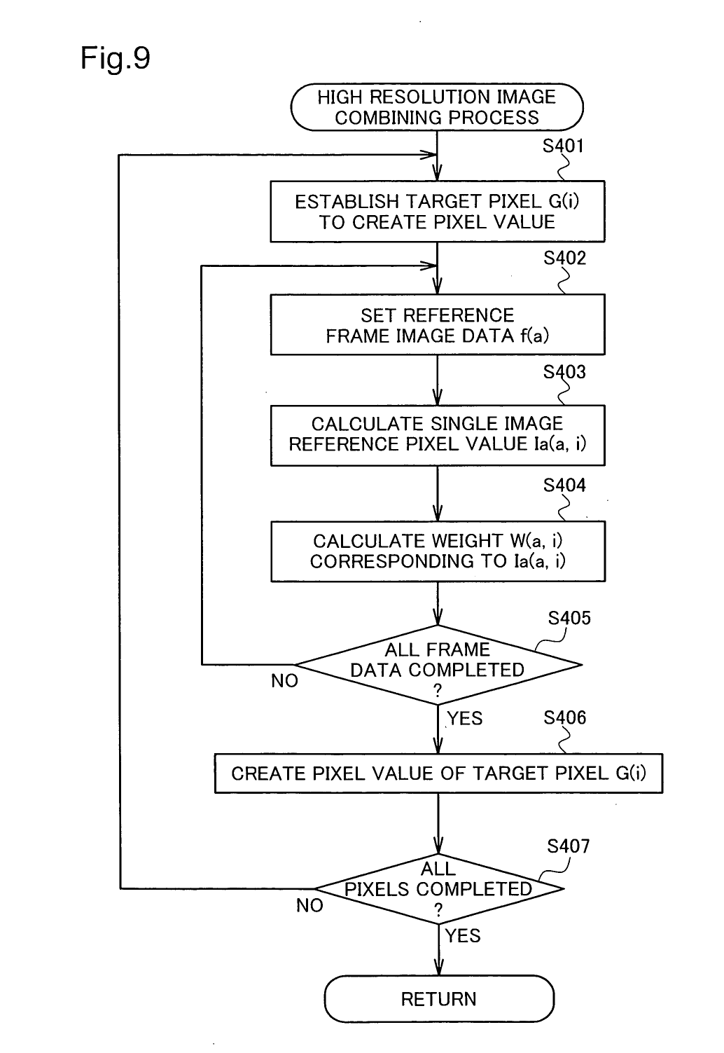

FIG. 9 is a flowchart showing the processing routine of the high resolution image combining process. When the high resolution image combining process is initiated, the CPU 200 first establishes locations of pixels forming the created image G represented by the created high resolution image data (created image data). CPU 200 then establishes, from among pixels whose locations have been established, a target pixel G(i) for creating pixel data (Step S401). i is a number for distinguishing among pixels. Here, the created image G and the pixels forming the created image G are described.

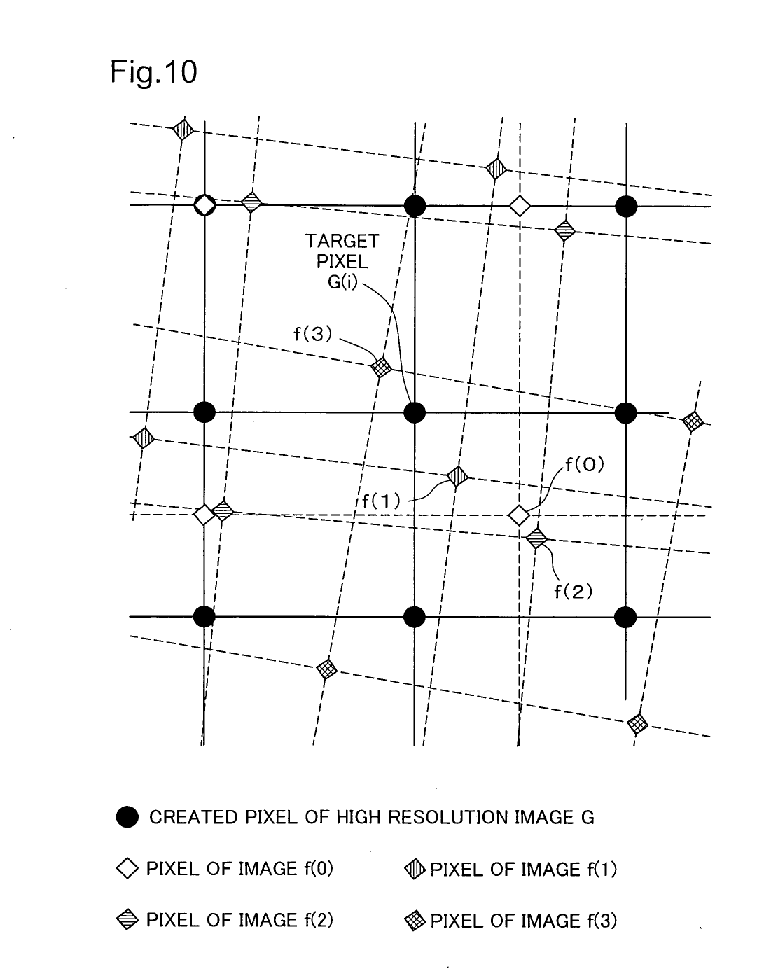

FIG. 10 is an enlarged illustration of an example of the base image f(0) and images f(1)-f(3), having undergone positional shift correction and superimposed so as to be partially aligned. In actual practice, 21 images are superimposed, but in FIG. 10 in order to simplify the drawing only four images f(0)-f(3) are shown, with the other images not being shown. In FIG. 10, pixels of the created image G are indicated by black circles, pixels of image f(0) are indicated by white squares, and pixels of images f(1)-f(3) are indicated by hatched squares. Vertical and lateral pixel density of the created image G are 1.5 times those of image f(0). Pixels of the created image G are situated at locations superimposed on pixels of image f(0), at two-pixel intervals. However, pixels of the created image G need not necessarily be positioned at locations superimposed on pixels of image f(0). Various other locations for pixels of the created image G are possible, such as all of the pixels being situated intermediate between pixels of image f(0). Vertical and lateral pixel density of the created image G is not limited to 1.5×, and can be established freely.

In the high resolution image combining process, all of the pixels that make up the aforementioned created image G are sequentially designated as the target pixel, and a pixel value is calculated for each to produce pixel data. The target pixel G(i) may be set, for example, sequentially starting from the pixel at the upper left edge of the created image G and going to the pixel at the upper right edge, and then starting from the pixel at the left edge and going to the pixel at the right edge of the row one below. The following description proceeds on the assumption that the pixel located at center in FIG. 10 has been established as the target pixel G(i).

Once a target pixel G(i) has been established, the CPU 200 set frame image data F(a) for reference (Step S402). In this process, when calculating the pixel value of one target pixel G(i), the frame image data F(a) used in combining are referred to sequentially one at a time. For example, these could be set starting at frame image data F(−10), in the order F(−9), F(−8), F(−7), . . . , F(9), F(10).

Next, on the basis of the currently set single frame data (hereinafter termed reference image data) F(a), the CPU 200 calculates the pixel value Ia(a,i) of the target pixel G(i) (Step S403). Hereinafter this pixel value Ia(a,i) shall be referred to as the single image reference pixel value. The single image reference pixel value Ia(a,i) is calculated By means of a interpolation technique such as the bi-linear method.

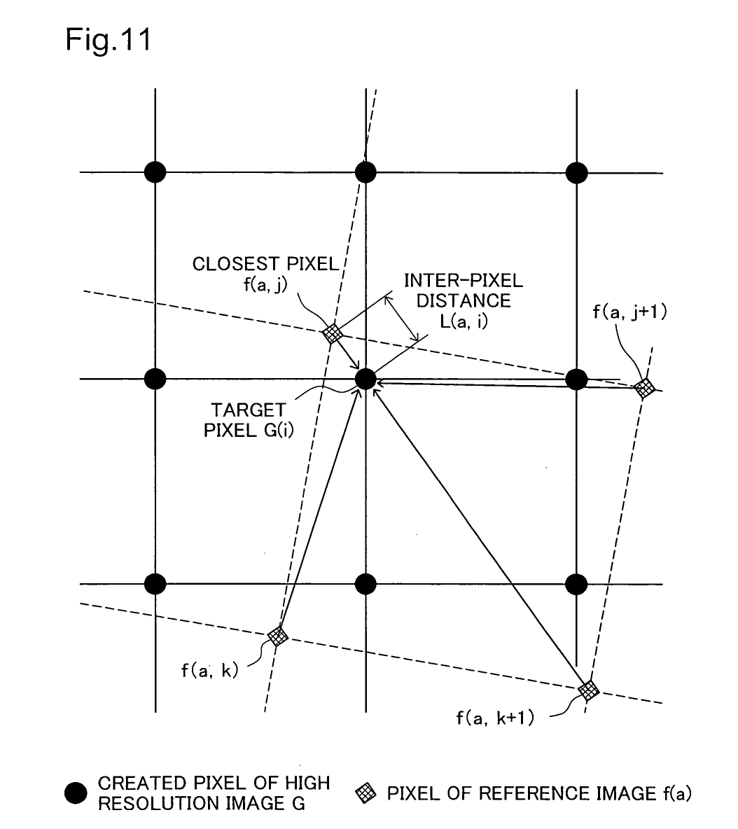

FIG. 11 is an illustration showing an interpolation process by the bi-linear method. As shown in FIG. 11, the CPU 200 divides an area defined by four pixels forming image f(a), which pixels surround the target pixel G(i) and are designated f(a, j), f(a, j+1), f(a, k), f(a, k+1), into four partitions by the target pixel G(i). The CPU 200 then multiplies pixel values of the four pixels f(a, j), f(a, j+1), f(a, k), f(a, k+1) weighting each by the area ratio of the partition located on the diagonal from each pixel, to calculate single image reference pixel value Ia(a,i). Pixel f(a, j) denotes the j-th pixel of f(a). k denotes the number of the pixel to which the pixel count in the lateral direction of image f(a) has been added to the j-th pixel.

With regard to interpolation technique for calculation of pixel value Ia(a,i), besides the bi-linear method, it would be possible to use various other interpolation techniques such as the bi-cubic method or nearest neighbor method.

The CPU 200 then calculates a weight W(a, i) for use when creating the created image data with the calculated single image reference pixel value Ia(a,i) (Step S404). This weight W(a, i) is made smaller for frame image data F(a) having a higher degradation-possibility, and is made larger for frame image data F(a) having a lower degradation-possibility. Here, the degradation-possibility means a possibility of degrading picture quality of the created image G when the frame image data F(a) is used to create the created image data. Establishment of weight W(a, i) is carried out using an indicator associated with each frame image data F(a), which indicator represents the possibility of degrading picture quality of the created image G.

Specifically, weight W(a, i) is given by the following equation, using an inter-pixel distance-based weight Ws(a, i), a time interval-based weight Wt(a), and a positional shift level-based weight Wu(a).
W(a, i)=Ws(a, i)×Wt(a)×Wu(a) (11)

The inter-pixel distance-based weight Ws(a, i), time interval-based weight Wt(a), and positional shift level-based weight Wu(a) differ in terms of the indicator used for calculation. These weights are described below.

The inter-pixel distance-based weight Ws(a, i) is a weight that is established using inter-pixel distance as the indicator. The inter-pixel distance is a distance between the target pixel G(i) and a pixel of image f(a), which pixel is situated closest to the target pixel G(i). In FIG. 11 the pixel situated closest indicated by symbol F(a, j) and the distance indicated by symbol L(a, i)). Accordingly, inter-pixel distance-based weight Ws(a, i) will differ for each target pixel G(i) and for each of the multiple frame image data F(a).

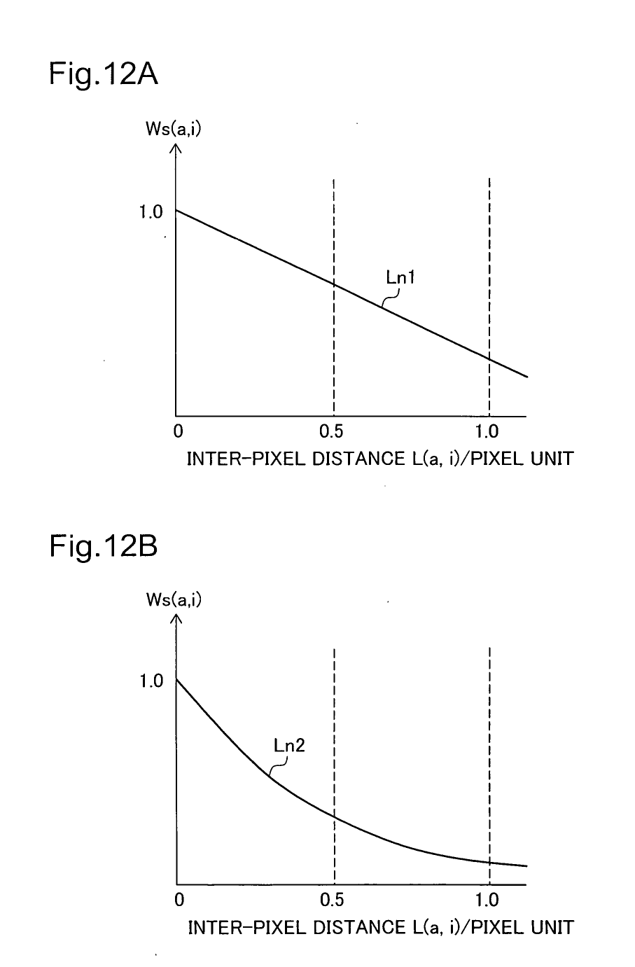

FIGS. 12A-B are illustrations describing calculation of inter-pixel distance-based weight Ws(a, i). Inter-pixel distance-based weight Ws(a, i) is established so as to be smaller the longer the inter-pixel distance L(a, i), and larger the shorter the inter-pixel distance L(a, i). For example, inter-pixel distance-based weight Ws(a, i) may decrease in linear fashion as the inter-pixel distance L(a, i) increases, as depicted in FIG. 12A. However, as Ws cannot assume a negative value, weight Ws(a, i)=0 above a certain inter-pixel distance. Alternatively, inter-pixel distance-based weight Ws(a, i) may be calculated using an exponential function (e.g. Eq. (12)) as depicted in FIG. 12B.
Ws(a, i)=exp{−L(a, i)/α} (α is a constant) (12)

The time interval-based weight Wt(a) is a weight that is established using as the indicator the time interval between the base frame image data F(0) selected as the base for combining and reference frame image data F(a). Time interval means the time difference between the time of creation of one frame image data and the time of creation of another frame image data. Where frame numbers are assigned sequentially in a time series, time interval can be represented by the difference between the frame number of the base frame image data F(0) and the frame number of reference frame image data F(a), so ultimately time interval-based weight Wt(a) is a value determined as a function of frame number a.

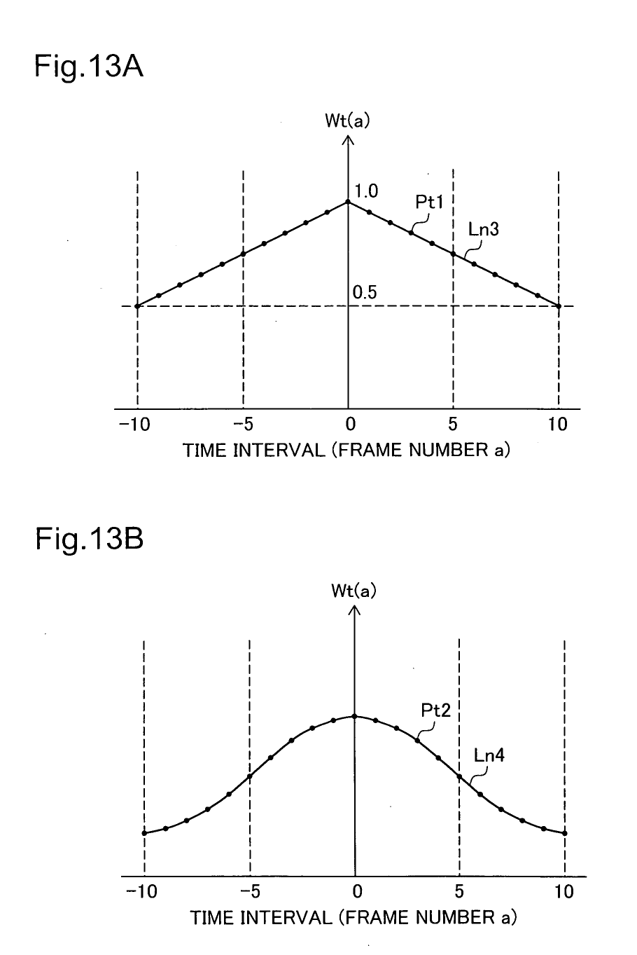

FIGS. 13A-B are an illustrations describing calculation of time interval-based weight Wt(a). Time interval-based weight Wt(a) is established so as to be smaller the longer time interval, and larger the shorter time interval. Specifically, it is smaller the larger the absolute value |a| of frame number a, and vice-versa. For example, time interval-based weight Wt(a) may decrease in linear fashion with increase in |a|, as depicted in FIG. 13A. Alternatively, time interval-based weight Wt(a) may be calculated using a normal distribution function as depicted in FIG. 13B.

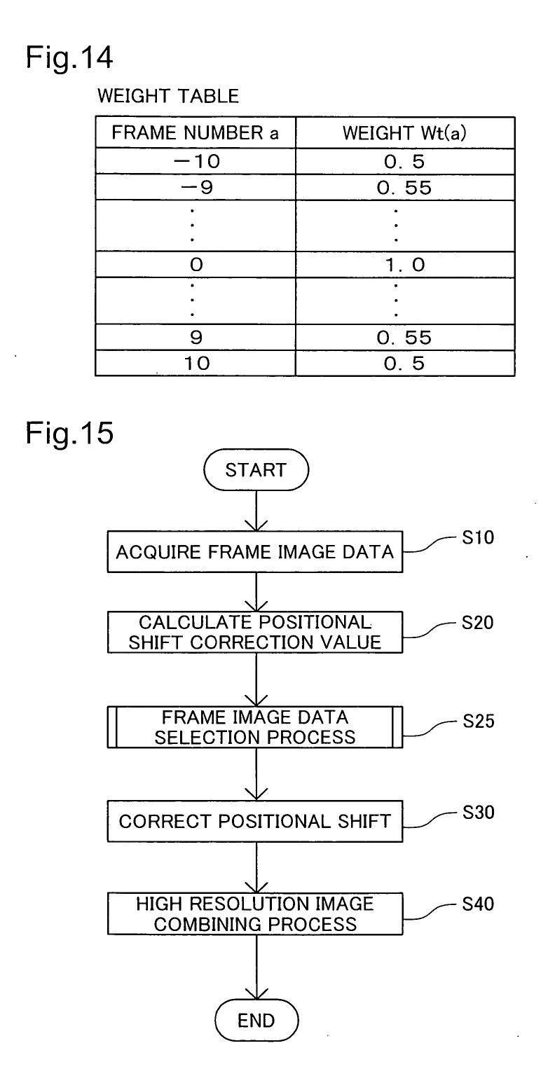

FIG. 14 is a simplified diagram showing a table in which time interval-based weights Wt(a) are recorded. Since ultimately time interval-based weights Wt(a) are values determined for each frame number a, in FIGS. 13A-B, correspondence relationships of numerical values indicated by symbol Pt1 or Pt2 to frame numbers may be recorded in advance as a table in the program. In this case, the CPU 200 will refer to the table to acquire time interval-based weights Wt(a).

The positional shift level-based weight Wu(a) is a weight established with a magnitude ΔM(a) of positional shift correction values (ua, va, δa) of the reference image f(a) with respect to the base image f(0) calculated in Step S20. The magnitude ΔM(a) of positional shift correction values can be calculated by the following Eq. (13), in consideration of the correction value of translational shift only, for example.
ΔM(a)=(ua²+va²)^{1/2} (13)

Of course, the correction value δa corresponding to rotational shift could be taken into consideration as well.

The positional shift level-based weight Wu(a) is established so as to be smaller the greater the magnitude ΔM(a) of positional shift correction values, and larger the smaller the magnitude ΔM(a) of positional shift correction values. For example, as with the first correction value Ws(a, i), positional shift level-based weight Wu(a) may decrease in linear fashion in association with increasing ΔM(a) of positional shift correction values; or may be calculated using an exponential function (e.g. Eq. (14)).
Wu(a)=exp{−ΔM(a)/β} (β is a constant) (14)

As described hereinabove, the CPU 200 can calculate weights W(a, i) using Eq. (11)-(14).

The description continues referring back to FIG. 9. Once the CPU 200 calculates a weight W(a, i), CPU 200 then determines whether reference has been made to all 21 frame image data F(a) (Step S405). In the event of a determination that there are frame image data F(a) to which reference has not yet been made (Step S405: NO), the CPU 200 returns to Step S402, refers to frame image data in question, and repeats the aforementioned Steps S403-S404.

In the event of a determination that all frame data has been referred to (Step S405: YES), the CPU 200 finally moves on to a process of calculating the pixel value (i) of the target pixel G(i) and producing pixel data of the target pixel G(i) (Step S406). At this point in time, by repeating the aforementioned Steps S403-S404, 21 single image data reference values Ia(a, i) referring to each of the multiple frame image data F(a) (a=−10 to +10), and 21 weights W(a, i) corresponding to each of these values Ia(a, i), are calculated for the target pixel G(i). The final pixel value (i) of the target pixel G(i) is given as the weighted average value of the the 21 single image data reference values Ia(a, i). Specifically, the CPU 200 calculates the final pixel value (i) of the target pixel G(i) by substituting these values into Eq. (15) below.

$$I ( i ) = \frac{{\sum }_{a} \{ W ( a , i ) \times Ia ( a , i ) \}}{{\sum }_{a} \{ W ( a , i ) \}} \qquad ( 15 )$$

The denominator of Eq. (15) is a coefficient for normalizing so that the total of the weights is equal to 1. Accordingly, the absolute values of weights W(a, i) are meaningless per se; only relative proportions among weights are significant. Once the CPU 200 has calculated the final pixel value (i) of a target pixel G(i), the process for that target pixel G(i) terminates.

Next, the CPU 200 determines whether pixel values (i) have been calculated for all pixels forming the created image G (Step S407). In the event of a determination that there are pixels for which pixel values (i) have not been created (Step S407: NO), the CPU 200 returns to Step S401, establishes a pixel for which a pixel value (i) has not been created as the target pixel G(i), and repeats the aforementioned Steps S402-S406.

In the event of a determination that pixel values (i) have been created for all pixels (Step S407: YES), the CPU 200 terminates the process. As a result, creation of high resolution image data (created image data) is complete. The created high resolution image data provided to the user, either output as a printed image by the printer 30, or output as a displayed image on the display device 40 or the monitor 25.

As described hereinabove, according to image processing pertaining to this embodiment, during combining of multiple frame image data F(a) to create high resolution image data (created image data), pixel data of the created image data are derived as weighted average values of single image data reference values Ia(a, i) using weights W(a, i). In other words, weight W(a, i) is a value representing the contribution of a single frame image data F(a) to the created image data. Accordingly, by adjusting the weights W(a, i) the effect of each frame image data in the created image data can be made to vary for each individual frame image data F(a). The weights W(a, i) are established so as to be smaller for image data for which it is more likely that frame image data will degrade the picture quality of the created image G, and larger for image data less likely to do so. As a result, the effect on the created image data of frame image data F(a) having high possibility of degrading the picture quality of the created image G is minimized. Accordingly, degradation of picture quality of the created image G can be reduced. The weights W(a, i) are established appropriately by using an indicator that represents the possibility of degradation of the picture quality of the created image G.

To describe the weight W(a, i) in more specific detail, the weight W(a, i) includes as a component thereof the aforementioned inter-pixel distance-based weight Ws(a, i) established with the aforementioned inter-pixel distance L(a, i) as its indicator. Since frame image data F(a) with longer inter-pixel distance L(a, i) only has pixels at locations relatively far away from the target pixel G(i), single image data reference values Ia(a, i) calculated on the basis of such frame image data F(a) provide information that gives rise to degradation of picture quality of the pixel value I(i) of the target pixel G(i) which is finally created and may have a high possibility of degrading picture quality of the created image (G). The inter-pixel distance-based weight Ws(a, i) is established so as to be smaller the longer the inter-pixel distance L(a, i), and greater the shorter the inter-pixel distance L(a, i). As a result, effects on the created image data by frame image data F(a) that is highly likely to degrade picture quality are minimized. Accordingly, degradation of the picture quality of the created image G can be reduced.

The weight W(a, i) includes as an additional component thereof the aforementioned time interval-based weight Wt(a) established with the aforementioned time interval (specifically, the absolute value of frame number |a|) as its indicator. From the viewpoint of the base image f(0), an image f(a) represented by frame image data F(a) having long time interval from the frame image data F(0) is highly likely to have experienced the aforementioned “movement.” Accordingly, single image data reference values Ia(a, i) calculated on the basis of frame image data F(a) with long time interval provide information that gives rise to degradation of picture quality (e.g. information of a subject that has experienced “movement”) of the pixel value I(i) of the target pixel G(i) which is finally created, and may have a high possibility of degrading picture quality of the created image (G). The time interval-based weight Wt(a) is established so as to be smaller the longer the time interval from the frame image data F(0), and greater the shorter this time interval. As a result, effects on the created image data by frame image data F(a) that is highly likely to degrade picture quality are minimized. Accordingly, degradation of the picture quality of the created image G can be reduced.

The weight W(a, i) includes as yet another component thereof the aforementioned positional shift level-based weight Wu(a) established with the aforementioned positional shift correction value magnitude ΔM(a) as its indicator. From the viewpoint of the base image f(0), an image f(a) represented by frame image data F(a) having high positional shift correction value with respect to the frame image data F(0) is highly likely to have experienced the aforementioned “movement.” In particular, there is a high possibility of “movement” involving relative change in subject location due to parallax produced by moving of the photographic device. Accordingly, single image data reference values Ia(a, i) calculated on the basis of frame image data F(a) with large positional shift correction value magnitude ΔM(a) provide information that gives rise to degradation of picture quality the pixel value I(i) of the target pixel G(i) which is finally created and may have a high possibility of degrading picture quality of the created image (G). The positional shift level-based weight Wu(a) is established so as to be smaller the greater the positional shift correction value magnitude ΔM(a), and greater the smaller this positional shift correction value magnitude ΔM(a). As a result, effects on the created image data by frame image data F(a) that is highly likely to degrade picture quality are minimized. Accordingly, degradation of the picture quality of the created image G can be reduced.

To put the above another way, the image processing device which pertains to this embodiment employs three indicators representing the possibility for degrading picture quality of a created image (G), namely, 1. inter-pixel distance L(a, i), 2. time interval |a|, and 3. positional shift correction value magnitude ΔM(a). By means of establishing appropriate weights W(a, i) with reference to these indicators, the combining proportion of frame image data F(a) likely to degrade picture quality is kept low, while the combining proportion of frame image data F(a) unlikely to degrade picture quality is kept high. As a result, degradation of the picture quality of the created image G can be minimized, and improved picture quality achieved.

Since calculation of the aforementioned weights W(a, i) is carried out using a table in which correspondence relationships between the weight and the possibility for degradation have been recorded in advance (see FIG. 14) or using a simple calculation equation (see Eq. 12 etc.), calculations can be performed quickly and easily.

### B. Second Embodiment

The following description of Second Embodiment pertaining to the invention makes reference to FIGS. 15-17. The arrangement of the image processing system pertaining to Second Embodiment and the functional arrangement of the personal computer 20 (CPU 200) are analogous to the arrangement of the image processing system pertaining to First Embodiment and the functional arrangement of the personal computer 20 (CPU 200) described with reference to FIG. 1 and FIG. 2; accordingly, the same symbols are used in the following description, omitting detailed description thereof.

Image Processing in Personal Computer 20

FIG. 15 is a flowchart showing the processing routine of image processing according to this embodiment. Steps identical to those of the processing routine of image processing pertaining to First Embodiment described previously with reference to FIG. 3 are assigned the same symbols and will not be described again.

A point of difference with image processing pertaining to First Embodiment is that there is an additional frame image data selection process, indicated by Step S25. This frame image data selection process is described hereinbelow.

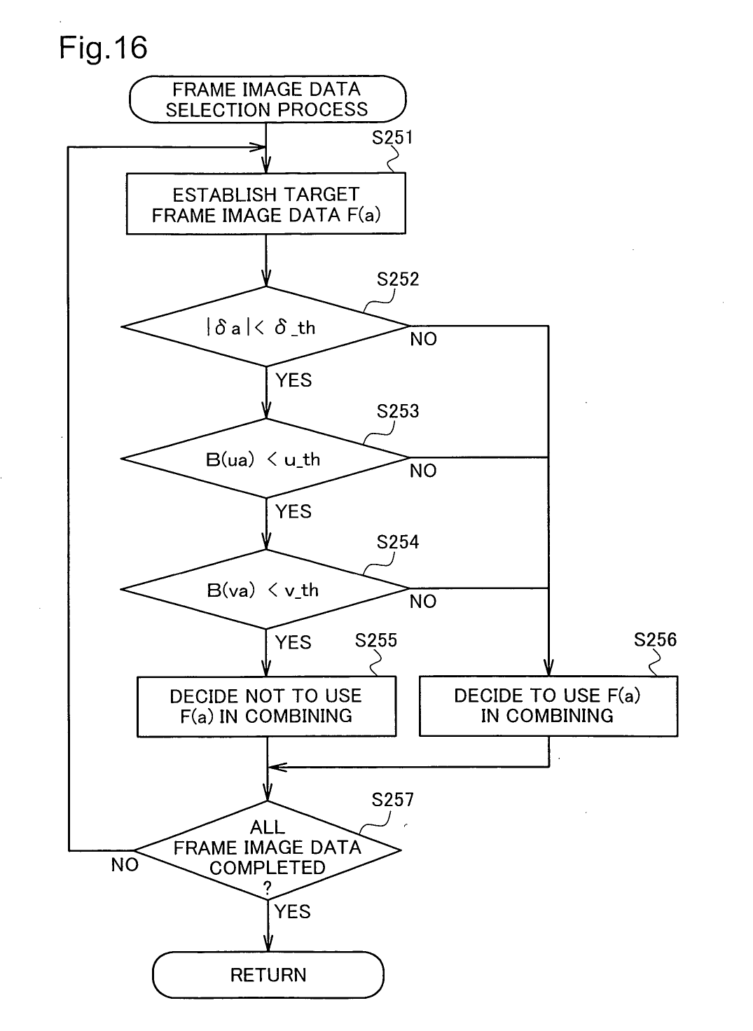

FIG. 16 is a flowchart showing the processing routine of the frame image data selection process. When the process is initiated, the CPU 200 establishes target frame image data F(a) (Step S251). In this process, all frame image data F(a) are targeted in sequence, determining for each of all frame image data F(a) whether it will be used in the high resolution image combining process of the subsequent Step S40. For example, target frame image data F(a) could be established starting at frame image data F(−10), in the order F(−9), F(−8), F(−7), . . . , F(9), F(10).

Next, in Step S20 the CPU 200 determines whether the positional shift correction values (ua, va, δa) calculated for the target frame image data F(a) fulfill all of the conditional equations (16)-(18) given below.
|δa|<δ_th (16)
|B(ua)|<u_th (17)
|B(va)|<v_th (18)

Here, B(x) represents the difference between x and the integer closest to x. For example, B(1.2)=0.2, B(0.9)=0.1. δ_th, u_th, and v_th are threshold values respectively decided in advance. Example settings are δ_th=0.01 (degree), u_th=1/8 (pixel unit), and v_th=1/8 (pixel unit). In the event that the CPU 200 determines that positional shift correction values (ua, va, δa) fulfill all of the conditional equations (16)-(18) (Step S252: YES, Step S253: YES, and Step S254: YES), CPU 200 decides not to use the target frame image data F(a) in the high resolution image combining process.

On the other hand, in the event that the CPU 200 determines that positional shift correction values (ua, va, δa) do not fulfill any one or more of the conditional equations (16)-(18) (Step S252: NO or Step S253: NO or Step S254: NO), CPU 200 decides to use the target frame image data F(a) in the high resolution image combining process (Step S256).

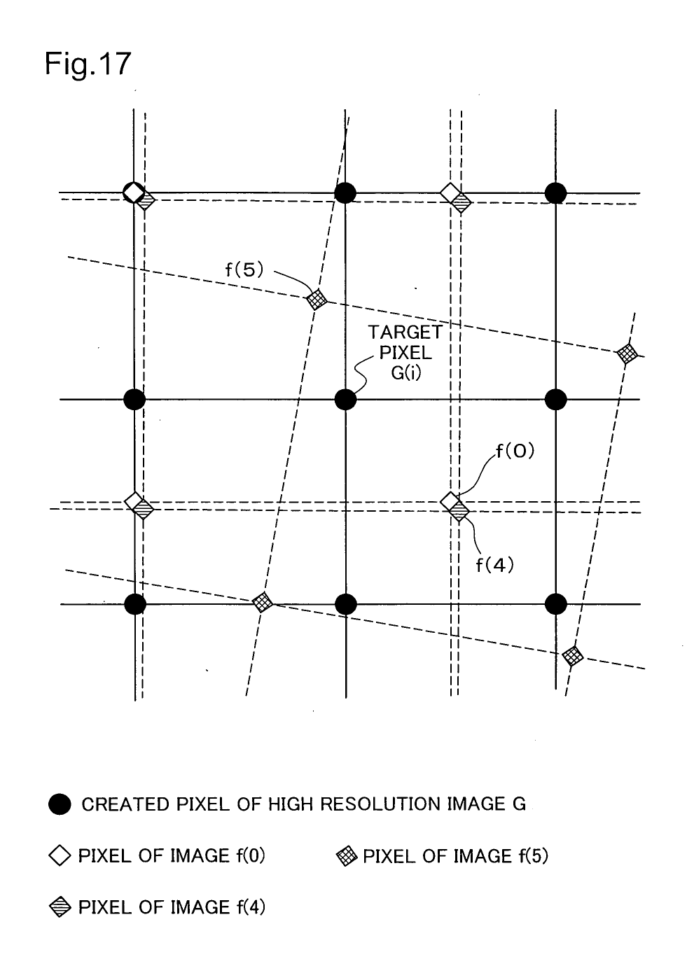

Here, frame image data F(a) determined to not be used in the high resolution image combining process and frame image data F(a) determined to be used in the high resolution image combining process will each be described. FIG. 17 is an enlarged illustration showing a baseline image f(0) and images f(4), f(5) subjected to positional shift correction and superimposed so as to be partially aligned. In FIG. 17, in order to simplify the drawing, only three images f(0), f(4), f(5) are depicted, with other images not shown.

Image f(4) in FIG. 17 is an example of an image represented by frame image data F(a) determined to fulfill predetermined conditions of equations (16)-(18), and decided to not be used in the high resolution image combining process. The pixels of image f(4) and the pixels of the base image f(0) are located at identical coordinates in the coordinate space of the created image. Here, “located at identical coordinates” does not require that coordinates are aligned exactly, but rather that coordinates are aligned at a predetermined level of sub-pixel unit accuracy (e.g. 1/8 pixel unit). Image data representing such an image (in the example of FIG. 17, frame image data F(4)) is termed duplicative image data.

The image represented by the duplicative image data (in the example of FIG. 17, image f(4)) merely imparts to the created high resolution image G (in FIG. 17, the image composed of pixels represented by black circles) the same information as the base image f(0), and does not contribute to creation of the high resolution image G.

Image f(5) in FIG. 17, on the other hand, is an example of an image represented by frame image data F(a) determined to be used in the high resolution image combining process. The pixels of image f(5) are located at different coordinates in the coordinate space of the created image than are the pixels of the base image f(0). That is, the pixels of image f(5) are present at locations filling in pixel intervals of the base image f(0). Such an image imparts to the created high resolution image G information different from the base image f(0), and thus contributes to creation of the high resolution image G.

The discussion continues referring back to FIG. 16. When CPU 200 determines whether target frame image data F(a) will be used in the high resolution image combining process, CPU 200 then determines whether this determination has been made for all 20 frame image data F(a) (a=−10 to 1, 1 to 10). In the event of a determination that there is a frame or frame image data F(a) that have yet to be determined (Step S257: NO), the CPU 200 returns to Step S251, targets the frame image data F(a) and repeats the aforementioned Steps S252-S256. In the event of a determination that the aforementioned determination has been made for all frame image data F(a) (Step S257: YES), the process terminates and returns to the process routine shown in FIG. 5.

As described hereinabove, according to the image processing device which pertains to this embodiment, there are afforded the following advantages, in addition to advantages similar to those afforded by the image processing device which pertains to First Embodiment. In the event that there exists duplicative image data representing frame image data that does not contribute to creation of a high resolution image G, this duplicative image data is not used in the high resolution image combining process (Step S40), whereby the processing load associated with the high resolution image combining process can be reduced. Additionally, since less frame image data is used for combining, the risk of double images can be reduced.

### C. Variations:

In the embodiments hereinabove, three factors are considered in weight W(a, i), but it would be acceptable to instead consider one or two of these elements. Specifically, whereas in the preceding embodiments, as indicated by Eq. (1), weight W(a, i) is calculated as the product of inter-pixel distance-based weight Ws(a, i) that takes inter-pixel distance into consideration, time interval-based weight Wt(a) that takes time interval into consideration, and positional shift level-based weight Wu(a) that takes positional shift correction value into consideration, it would be acceptable by way of a variation to instead use the inter-pixel distance-based weight only, for example, to calculate W(a, i) using Eq. (18) below, or to use the inter-pixel distance-based weight and time interval-based weight to calculate W(a, i) using Eq. (19).
W(a, i)=Ws(a, i) (18)
W(a, i)=Ws(a, i)×Wt(a) (19)

In this case, degradation of picture quality of a created image G due to the factor(s) taken into consideration can be reduced.

While it is necessary to establish inter-pixel distance-based weights Ws(a, i) on an individual pixel basis for pixels forming a created image G and on an individual frame image data F(a) basis (i.e. pixel count×frame image data count), positional shift level-based weight Wu(a) and time interval-based weight Wt(a) may be established on an individual frame image data F(a) basis only (i.e. frame image data count). Accordingly, where only positional shift level-based weight Wu(a) and time interval-based weight Wt(a) are employed, load of calculation may be deduced in the image processing routine. For example, by calculating weights all at once after Step S30 and prior to Step S40 in the flowchart shown in FIG. 3, the calculated weights may be used as-is in the subsequent high resolution image combining process.

In the preceding embodiments, positional shift level-based weights Wu(a) are smaller in association with a higher levels of positional shift correction; however, it would be acceptable instead to establish a threshold value in advance, and in the event that positional shift correction value exceeds the threshold value, to not use that frame image data F(a) in the high resolution image combining process, or to assign a value of 0 to the weight Wu(a). In this case, frame image data F(a) deemed highly likely to experience “movement” and cause degradation of picture quality of a created image can be excluded, and degradation of picture quality of the created image G can be reduced.

Whereas in the preceding embodiments, multiple frame image data are acquired from video data created by a digital video camera 10, the mode of acquisition of multiple image data for use in creating high resolution image data is not limited to this. For example, it would be possible instead to use video data shot by a digital still camera in video shooting mode, multiple still image data continuously shot with a digital still camera equipped with a continuous shooting function, or other multiple image data arranged in a time series. Continuous shooting function refers to a function whereby multiple clips are shot continuously at high speed, typically without the data being transferred to a memory card, but rather stored as image data in high speed memory (buffer memory) within the digital still camera.

In the image processing device pertaining to the embodiments, positional shift correction value was calculated by the gradient method, but could be calculated by some other method instead. For example, after calculating positional shift correction value roughly (e.g. at pixel unit accuracy) By means of a known pattern matching method, positional shift correction value could then be calculated with higher accuracy (i.e. sub-pixel unit accuracy) by means of the gradient method.

Also, it would be possible to equip the digital video camera 10 with an angular velocity sensor, and to acquire thereby information relating to change in orientation of the digital video camera 10 during creation of frame image data, this information being output together with the frame image data to the image processing device. In this case, positional shift correction value can be calculated using the information relating to change in orientation.

Although image processing of the present invention have been described above in terms of embodiments, these embodiments of the invention are only purposed to facilitate understanding of the present invention and are not considered to limit the present invention. There may be various changes, modifications, and equivalents without departing from the spirit or scope of the claims of the present invention.

The Japanese patent application No.2004-204745(filing date: Jul. 12, 2004) as the basis of the priority claim of this application are incorporated in the disclosure hereof by reference.

What is claimed is:

1. An image processing device that creates high resolution image data using multiple image data arranged in a time series, wherein the multiple image data are respectively composed of multiple first pixel data, wherein the high resolution image data has higher resolution than the multiple image data, the image processing device comprising:
an image data acquisition module that acquires the multiple image data;
a correction value calculation module that calculates a correction value for correction of a positional shift of a subject among images represented by the multiple image data;
a positional shift correction module that corrects the positional shift of the subject about the multiple image data respectively using the calculated correction value;
a weight establishing module that establishes a weight for each of the multiple image data, wherein the weight decreases as a degradation-possibility increases and increases as the degradation-possibility decreases, wherein the degradation-possibility is a possibility for degrading a quality of a image represented by the high resolution image data when one of the multiple image data uses for creating the high resolution image data; and
a high resolution image creating module that creates the high resolution image data by combining the corrected multiple image data using the established weight.

2. An image processing device according to claim 1, wherein
the establishment of the weight is carried out using an indicator associated with each of the multiple image data, the indicator representing a degree of the degradation-possibility.

3. An image processing device according to claim 2,
wherein the indicator includes a time interval between each of the multiple image data and base image data selected from among the multiple image data, and
wherein the weight establishing module comprises a time interval-based weight establishing module that establishes smaller weight for image data having the longer time interval, and larger weight for image data having the shorter time interval.

4. An image processing device according to claim 2,
wherein the indicator includes a magnitude of the correction value between an image represented by each of the multiple image data and an image represented by base image data selected from among the multiple image data, and
wherein the weight establishing module comprises a positional shift level-based weight establishing module that establishes smaller weight for image data having the larger correction value, and larger weight for image data having the smaller correction value.

5. An image processing device according to claim 2,
wherein the indicator includes an inter-pixel distance between second pixel data and closest pixel data, wherein the second pixel data forms the high resolution image data, wherein the closest pixel data is the closest to the second pixel data among the all first pixel data forming each of the corrected multiple image data, wherein the inter-pixel distance is set for each of the second pixel data, and
wherein the weight establishing module comprises an inter-pixel distance-based weight establishing module that establishes smaller weight for image data having the longer inter-pixel distance, and larger weight for image data having the shorter inter-pixel distance.

6. An image processing device according to claim 1, wherein
the high resolution image creating module comprises:
a pixel establishing module that establishes a position of a pixel forming an image represented by the high resolution image data;
a single image reference pixel value calculating module that calculates a single image reference pixel value on a per-pixel data basis, wherein the single image reference pixel value is a pixel value at the established position calculated on the basis of one image data among the corrected multiple image data; and
a pixel data creating module that calculates a weighted average of the single image reference pixel values using the established weights to create pixel data at the established position using the weighted average as a pixel value.

7. An image processing device according to claim 2 further comprises
a memory that stores a table in which correspondence between the indicator and the weight is recorded in advance,
wherein the weight is established with reference to the table.

8. An image processing device according to claim 2, wherein
the weight is established using a prescribed relational expression representing correspondence between the indicator and the weight.

9. An image processing device according to claim 1, wherein
when duplicative image data exists, wherein the duplicative image data is one of the corrected multiple image data, wherein each of pixels forming an image represented by the duplicative image data is located at substantially identical coordinates as each of pixels of an image represented by another one of the corrected multiple image data in the coordinate space of an image represented by the high resolution image data,
the creation of the high resolution image data is executed without using the duplicative image data.

10. An image processing device according to claim 9, wherein
when a first value meets a predetermined criterion, wherein the first value is the correction value between an image represented by one of the corrected multiple image data and an image represented by another of the corrected multiple image data,
the one of the corrected multiple image data is determined to be the duplicative image data.

11. An image processing method of creating high resolution image data using multiple image data, wherein the multiple image data are respectively composed of multiple pixel data, wherein the multiple image data are arranged in a time series, wherein the high resolution image data has higher resolution than the multiple image data, the image processing method comprising:
acquiring the multiple image data;
calculating a correction value for correction of a positional shift of a subject among images represented by the multiple image data;
correcting the positional shift of the subject about the multiple image data respectively using the calculated correction value;
establishing a weight for each of the multiple image data, wherein the weight decreases as a degradation-possibility increases and increases as the degradation-possibility decreases, wherein the degradation-possibility is a possibility for degrading quality of a image represented by the high resolution image data when each of the multiple image data uses for creating the high resolution image data; and
creating the high resolution image data by combining the corrected multiple image data using the established weight.

12. An image processing method according to claim 11, wherein
the establishment of the weight is carried out using an indicator associated with each of the multiple image data, the indicator representing a degree of the degradation-possibility.

13. An image processing method according to claim 12,
wherein the indicator includes a time interval between each of the multiple image data and base image data selected from among the multiple image data, and
wherein the established weight includes a time interval-based weight set smaller for image data having the longer time interval and larger for image data having the shorter time interval.

14. An image processing method according to claim 12,
wherein the indicator includes a magnitude of the correction value between an image represented by each of the multiple image data and an image represented by base image data selected from among the multiple image data, and
wherein the established weight includes a positional shift level-based weight set smaller for image data having the larger correction value and larger for image data having the smaller correction value.

15. An image processing method according to claim 12,
wherein the indicator includes an inter-pixel distance between second pixel data and closest pixel data, wherein the second pixel data forms the high resolution image data, wherein the closest pixel data is the closest to the second pixel data among the all first pixel data forming each of the corrected multiple image data, wherein the inter-pixel distance is set for each of the second pixel data, and
wherein the established weight includes an inter-pixel distance-based weight set smaller for image data having the longer inter-pixel distance and larger for image data having the shorter inter-pixel distance.

16. An image processing method according to claim 11, wherein
the creating the high resolution image comprises:
establishing a position of a pixel forming an image represented by the high resolution image data,
calculating a single image reference pixel value on a per-pixel data basis, wherein the single image reference pixel value is a pixel value at the established position calculated on the basis of one image data among the corrected multiple image data, and
calculating a weighted average of the single image reference pixel values using the established weights to create pixel data at the established position using the weighted average as a pixel value.

17. An image processing method according to claim 11, wherein
when duplicative image data exists, wherein the duplicative image data is one of the corrected multiple image data, wherein each of pixels forming an image represented by the duplicative image data is located at substantially identical coordinates as each of pixels of an image represented by another one of the corrected multiple image data in the coordinate space of an image represented by the high resolution image data,
the creating of the high resolution image data is executed without using the duplicative image data.

18. An image processing method of creating high resolution image data using multiple image data arranged in a time series, wherein the multiple image data are respectively composed of multiple first pixel data, wherein the high resolution image data has higher resolution than the multiple image data, the image processing method comprising:
acquiring the multiple image data;
calculating a correction value for correction of a positional shift of a subject among images represented by the multiple image data;
establishing at least one of a first weight and a second weight for each of the multiple image data, wherein the first weight is established smaller for image data having the longer time interval from reference image data and larger for image data having the shorter time interval, wherein reference image data is selected from among the multiple image data, wherein the second weight is established smaller for image data having the larger correction value and larger for image data having the smaller correction value, wherein the correction value between each of the multiple image data and the base image data;
correcting the positional shift of the subject about the multiple image data respectively on the basis of the correction value; and
creating the high resolution image data by combining the corrected multiple image data using the established weight.

19. An image processing method of creating high resolution image data using multiple image data, wherein the multiple image data are respectively composed of multiple pixel data, wherein the multiple image data are arranged in a time series, wherein the high resolution image data has higher resolution than the multiple image data, the image processing method comprising:
acquiring the multiple image data;
calculating a correction value for correction of a positional shift of a subject among images represented by the multiple image data;
correcting the positional shift of the subject about the multiple image data respectively using the calculated correction value;
calculating an inter-pixel distance for each of second pixel data forming the high resolution image data, wherein the inter-pixel distance indicates distance between the second pixel data and pixel data closest to the second pixel data among all first pixel data forming each of the corrected image data;
establishing a weight for each of the multiple image data, wherein the established weight is smaller for image data having the longer inter-pixel distance and larger for image data having the shorter inter-pixel distance; and
creating the high resolution image data by calculating values of the second pixel data using the established weights and each of multiple image data.

20. A computer program product for executing image processing on the computer, wherein the image processing includes creating high resolution image data using multiple image data arranged in a time series, wherein the multiple image data are respectively composed of multiple pixel data, wherein the high resolution image data has higher resolution than the multiple image data, the computer program product comprising:
a computer readable medium; and
a computer program stored on the computer readable medium, the computer program comprising:
a program instruction for acquiring the multiple image data;
a program instruction for calculating a correction value for correction of a positional shift of a subject among images represented by the multiple image data;
a program instruction for correcting the positional shift of the subject about the multiple image data respectively using the calculated correction value;
a program instruction for establishing a weight for each of the multiple image data, wherein the weight decreases as a degradation-possibility increases and increases as the degradation-possibility decreases, wherein the degradation-possibility is a possibility for degrading quality of a image represented by the high resolution image data when each of the multiple image data uses for creating the high resolution image data; and
a program instruction for creating the high resolution image data by combining the corrected multiple image data using the established weight.
